(19) United States
(12) Patent Application Publication
(10) Pub. No.: US 2014/0076947 A1
(43) Pub. Date: Mar. 20, 2014

(54) TWO-STAGE CLAMP FOR GLASS TRANSPORT

(71) Applicant: Alex McDonald, Houston, TX (US)

(72) Inventor: Alex McDonald, Houston, TX (US)

(21) Appl. No.: 13/415,692

(22) Filed: Mar. 8, 2012

(51) Int. Cl. B60R 9/02

(52) U.S. Cl. CPC B60R 9/02
USPC 224/401

(57) ABSTRACT

A two-stage clamp for holding glass in place during transport is disclosed. Glass is clamped in place by manually pushing a rubber clamping member against the glass with the desired second-stage clamping force, and then clamping the rubber member in place by rotating a handle which is attached to a cam which provides the second-stage clamping force. A threaded shaft facilitates one-time adjustment of the mechanism such that subsequently the second-stage clamping force of the cam will be consistent in the clamped state and will not require adjustment the next time the clamp is used. The clamp may easily be operated by a gloved hand.

### FIELD OF THE INVENTION

The field of the invention relates to transport systems for sheet materials, glass racks, clamps, and more specifically to clamping sheets of glass in place during transport.

### BACKGROUND OF THE INVENTION

For as long as glass windows have been commercially available, various methods and apparatus have evolved for transporting sheets of glass from manufacturer to distributor, and from distributor to consumer. Modern consumers of sheet glass are mainly businesses, since most glass which gets installed in residences is already pre-installed in window frames, mirror frames, and the like, whereas windows and mirrors installed in businesses are often large sheets of glass which are delivered un-framed.

There are two classes of modern glass delivery trucks: large, heavy-duty large-capacity glass trucks which are used for delivering glass from manufacturers to distributors (or to large construction sites during initial construction), and small, lighter-duty trucks that are used for delivering glass from distributors to small construction sites or repair job sites.

Large glass delivery trucks, such as shown in FIG. 1, typically consist of a truck cab-chassis (including engine, transmission, frame, wheels, etc.) manufactured by a vehicle company such as International, with a custom-built body (including glass racks) permanently installed on the frame by a glass truck manufacturer such as Unruh Fab Inc. These trucks are typically purchased by glass manufacturers or wholesalers, and are used to make deliveries to wholesalers, distributors, or the construction site of an office building, hotel or the like.

Glass shops typically use smaller glass-carrying trucks such as those shown in FIGS. 2 and 3 as well as trailers and vans. Within this document, the term “vehicle-mounted rack” shall be construed to include a rack mounted on a trailer. These trucks are typically standard pickup trucks which have been made into glass delivery vehicles by bolting a glass rack to the pickup bed and/or bed wall rails and other attachment points. To attach the glass-carrying rack, holes are typically drilled in the truck body to accommodate bolts to attach the glass-carrying rack. Sometimes the pickup truck modification is done by end users (for instance glass shop owner/operators), and sometimes the pickup truck modification is done by a glass truck manufacturer or an approved installer.

When transporting glass, stone and other large flat materials, one needs to hold the material against the rack so that it does not fly off or rattle and get damaged. In the industry a number of methods are used. The primary methods are straps that hold the glass against the rack or a system of stakes that are attached to the rack and that have rubber cleats (such as shown in FIGS. 4 and 5) that hold the glass against the rack or other pieces of glass. In simple glass clamps known in the art, removable stakes are put in place after glass is loaded, and then rubber clamping cleats are fastened to the stakes with nut and bolt assemblies. The fastening is typically done by tightening a wing nut or knurled nut by hand.

There are several drawbacks of the above-described clamping mechanism. First, every time someone loads or unloads a piece of glass, one needs to loosen a number of these cleats and remove the stakes so that one can have access to the glass. Often, the part that takes the most time is unscrewing and re-screwing the nuts that hold the cleats in place. During disassembly, or during transport with the rack empty and clamps not tightened, the nuts, bolts, and washers of such clamping mechanisms may be subject to loss. Further, it may be difficult for a person wearing a glove to have the dexterity required to hand-tighten such a mechanism quickly, and it is desirable for glass workers to wear gloves for safety. Another potential problem is that tightening is “by feel”, and thus uniformity of tightening is likely to be inconsistent.

A scissor-type stake-mounted glass clamping mechanism known in the art is shown in FIG. 6. While this type of clamping mechanism is quick to operate and is typically not subject to parts loss (because it is meant to remain attached to the stake it is mounted on), this mechanism is quite expensive compared to simple glass clamping mechanisms shown in FIGS. 4 and 5, and thus is not nearly as frequently used.

There is a need in the art for an inexpensive glass clamping mechanism that is quick to operate, can easily be operated by a gloved hand, is easy to clamp in a consistent way, and is not prone to parts loss in the field.

### SUMMARY OF THE INVENTION

It is an object of the present invention to provide a quick and reliable way of clamping sheets of glass in place during transport. It is a further object of the present invention to facilitate securing glass sheets for transport with a mechanism that can be easily operated by a gloved hand. It is a further object of the present invention to provide a glass-clamping mechanism that is not subject to parts loss.

In one aspect, the present invention provides a clamping mechanism that can be aligned and clamped in a second, by someone wearing gloves.

Glass or other sheet material is clamped in place by manually pushing a rubber-surfaced clamping cleat against the glass with the desired second-stage clamping force, and then clamping the rubber member in place by rotating a handle which is attached to a cam which provides the second-stage clamping force. A threaded shaft facilitates one-time adjustment of the mechanism such that subsequently the second-stage clamping force of the cam will be consistent in the clamped state and will not require adjustment the next time the clamp is used. The clamp may easily be operated by a gloved hand.

### BRIEF DESCRIPTION OF THE DRAWINGS

FIG. 1 is a photo of a typical large heavy-duty modern glass delivery truck.

FIG. 2 is a photo of a typical light-duty modern glass delivery truck with an aluminum glass rack.

FIG. 3 is a photo of a typical light-duty modern glass delivery truck with a steel glass rack.

FIG. 4 depicts a typical glass clamp known in the art, employing a triangular rubber cleat.

FIG. 5 is a photograph of rubber cleat typically used for clamping glass, and the typical fastening hardware known in the art to fasten the cleat in the desired clamping position.

FIG. 6 is a photograph of a rubber-faced scissor mechanism known in the art for clamping glass sheets in place during transport.

FIG. 7 is a photograph of an embodiment of a glass clamp according to the present invention, shown with the clamp actuated.

FIG. 8 is a photograph of an embodiment of a glass clamp according to the present invention, shown with the clamp released.

FIG. 9A depicts a side view of the clamping mechanism of the present invention, with the clamping mechanism actuated.

FIG. 9B depicts a side view of the clamping mechanism of the present invention, with the clamping mechanism released.

FIG. 10A depicts an embodiment of the present invention where the cleat height is fixed vertically along the stake and the stake is not a box beam.

FIG. 10B depicts an embodiment of the present invention where the cleat height is fixed vertically along the stake and the stake is a box beam.

FIG. 10C depicts an embodiment of the present invention where the cleat height is variable vertically along the stake and the stake is a “C” beam or a box beam with a slot cut vertically in one face.

FIG. 11 shows the relative hardness of various resiliently deformable materials, such as polymers, elastomers, and rubbers as measured on the Shore A Durometer, Shore D Durometer, and Rockwell R hardness scales.

FIG. 12 depicts three styles of extruded stakes, with one, two, and four slots which can capture a bolt head such that the threaded shaft of the bolt protrudes from the surface of the stake and the bolt can be slid up and down the stake.

FIG. 13 depicts examples of alternate preferred embodiments of the present invention.

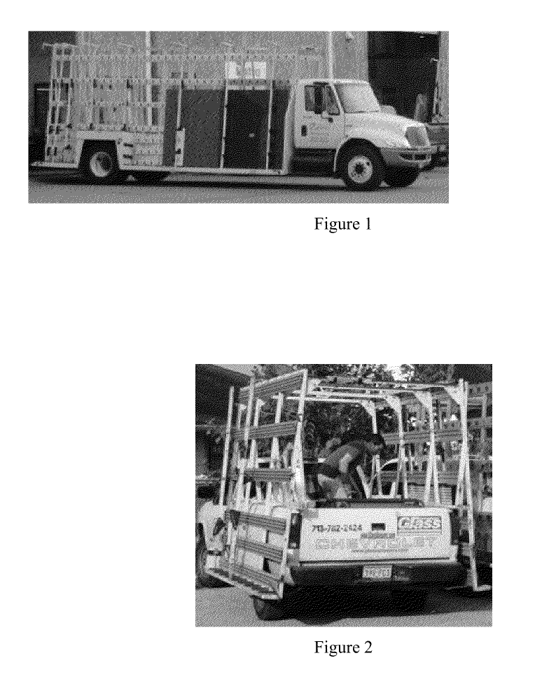

### DETAILED DESCRIPTIONS OF SOME PREFERRED EMBODIMENTS

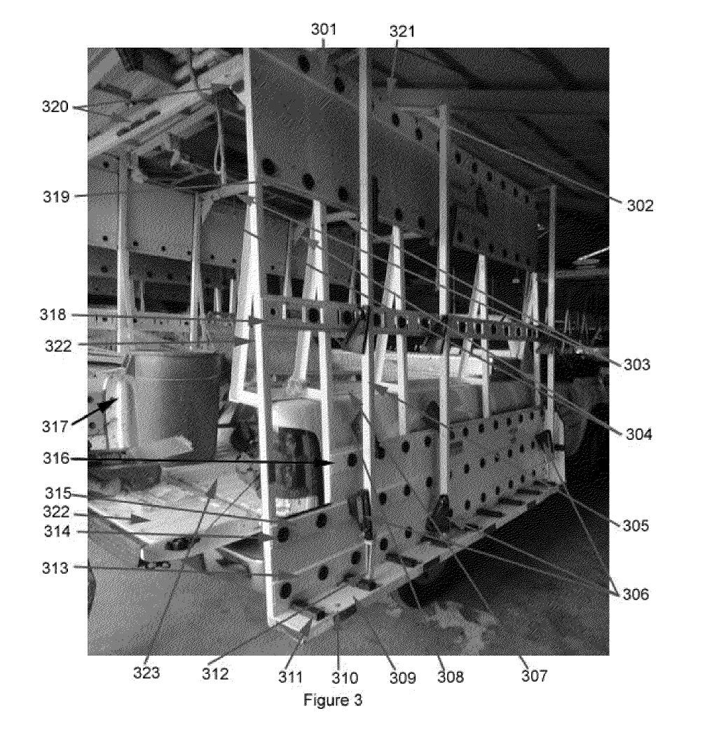

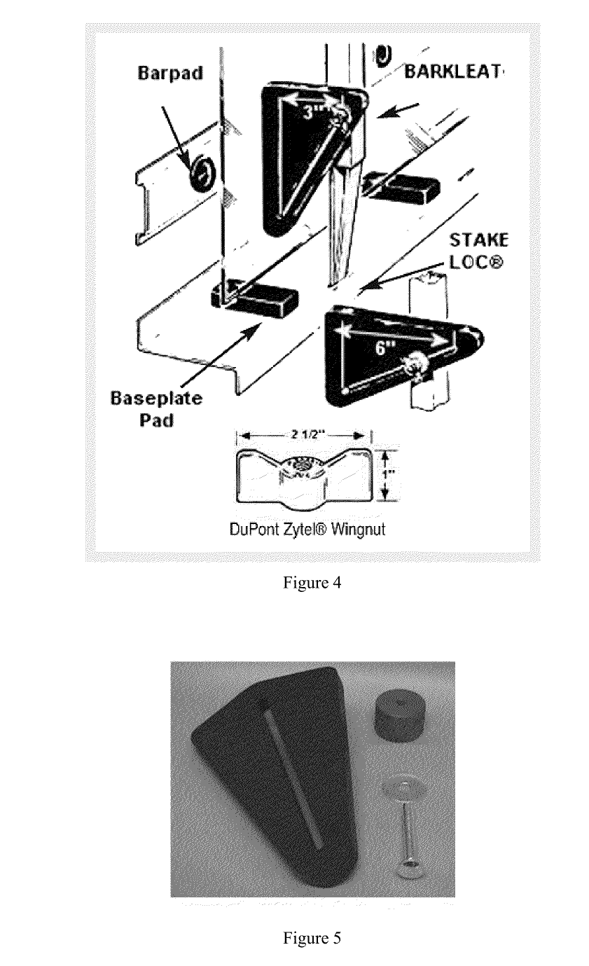

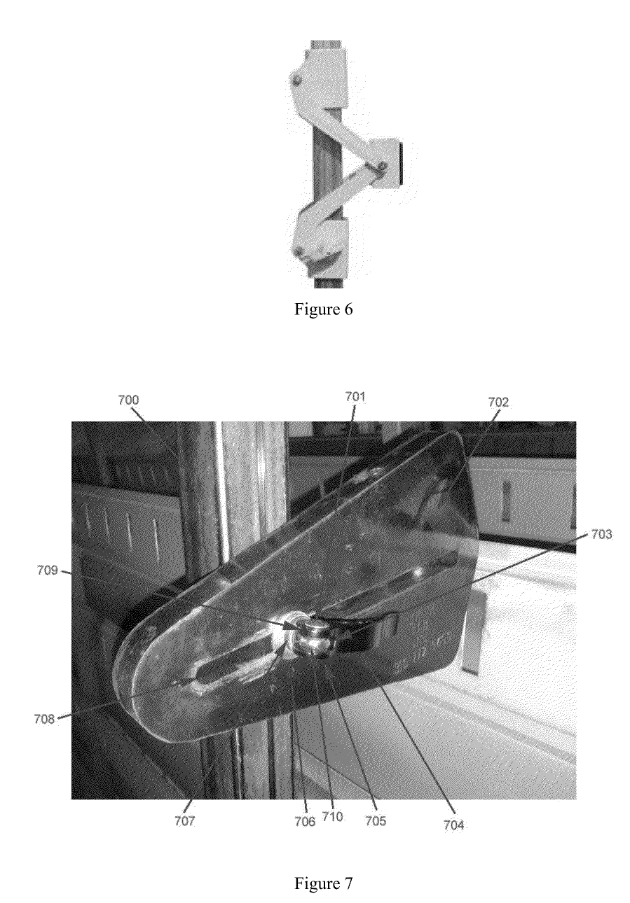

The term “glass rack” as used in this document shall be construed to mean a rack suitable for transporting glass or other sheet material, or stone slabs or the like. FIG. 3 is a photo of a typical modern light-duty glass delivery truck with a glass rack installed. Mounting rail 307 bolts to truck bed wall rail 308 and supports the weight of the glass rack on truck bed wall rail 308. The plane in which the interface between mounting rail 307 meets truck bed wall rail 308 shall be referred to in this document as the “primary plane of attachment”.

Glass or other sheet material which is loaded on the rack rests edge-wise on rubber pads 311 and the majority of the weight of the glass is transferred to lower support rail 309 through pads 311. A small fraction of the weight of glass or other sheet material loaded on the rack rests on surface pads 314 (also sometimes called “buttons”), which are mounted along first (lower) face rail 313, second face rail 315, third face rail 316, fourth face rail 318, fifth face rail 319, and 6^{th} (top) face rail 301. All face rails are mounted to vertical frame members 322. Face rails are also referred to in the industry as slats. Typically, lower support rail 309 is provided with stake holes 310 into which the lower pointed end 312 of stakes 305 fit. Rubberized clamping blocks 306 (also sometimes called cleats) which attach to stakes 305 may be adjusted to push glass or other sheet material being transported against surface pads 314 (which may be round as in FIG. 3 or strip-shaped as in FIG. 2), which are typically also rubberized. Upper stake brackets 302 may be affixed to stakes 305 and removably engageable with the top surface 321 of upper face rail 301, or upper stake brackets 302 may be attached to upper face rail 301, and removably engaged with the upper end of stakes 305. Different manufacturers of pickup-truck-mountable glass racks may use different numbers of face rails, depending on the height and style of their racks.

While mounting the rack to truck bed sidewall rails 308 provides load bearing support, and torsional support around all axes perpendicular to the direction of travel of the truck, additional torsional bracing such as corner braces 304, combined with upper torsion braces 303 are typically needed to give the rack torsional stability around an axis parallel with the direction of travel of the truck. Equivalently, some racks accomplish such torsional bracing by bolting braces between lower support rail 309 and fixed mounting points underneath the truck toward the front and rear of the rack. Some racks may also be equipped with reflectors and/or lighting 320 to enhance visibility and safety on the road.

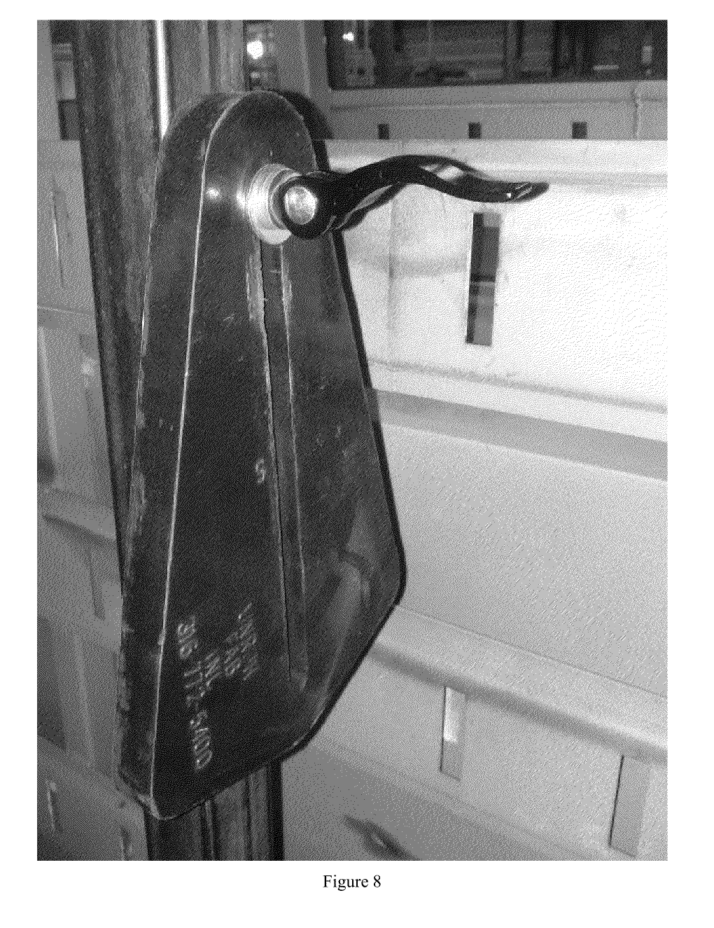

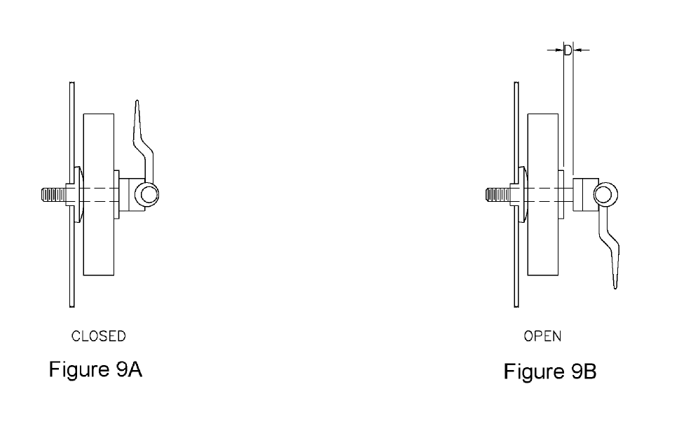

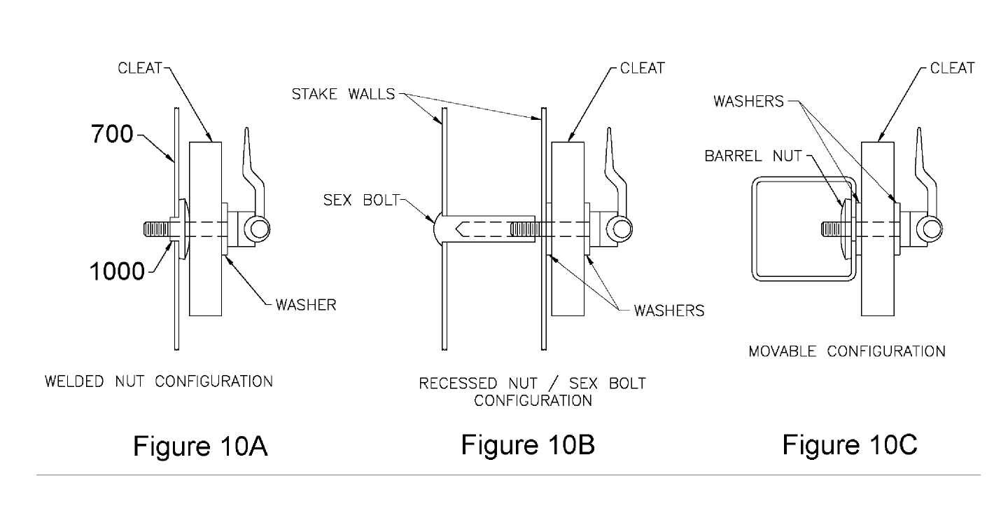

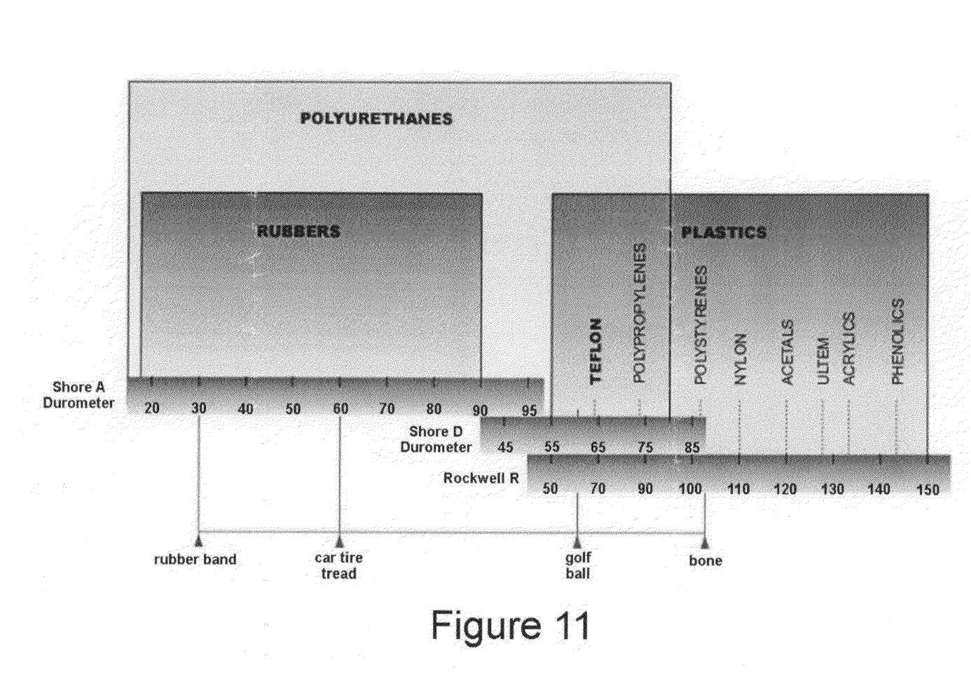

Photographs of preferred embodiments of the present invention are shown in FIGS. 7 and 8. Rubber-surfaced cleat 702 (typically of Shore A Durometer between 70 and 90) is fastened to stake 700 by being clamped between washer 706 and stake 700. Threaded member 710 extends into slot 703 in cam 705 and in a preferred embodiment is coupled to cam 705 by a pin whose axis is coincident with axis 701. Threaded member 710 is held in tension in the clamped state in reaction to the clamping force put on washer 706 by eccentric surface 709 of cam 705. As torque is applied using handle 704 to rotate cam 705 about axis 701, the distance from axis 701 to washer 706 is varied by the eccentricity of cam surface 709 about axis 701. Threaded member 710 passes through slot 708, allowing cleat 702 to be positioned against the surface of glass or other sheet material to be transported, prior to rotating handle 704 to clamp cleat 702 to stake 700. Threaded member 710 passes through the surface of stake 700 as shown for various preferred embodiments of the present invention shown in FIGS. 10A, 10B, and 10C.

In FIG. 10A, nut 1000 is welded to the wall of stake 700 and threaded member 710 threads into nut 1000. In such an embodiment where threaded member 710 threads into female threads which are effectively welded to cleat 700, such female threads will be deemed to be a part of stake 700, and threaded member 710 engaging in such threads will be deemed to be threaded member 710 passing through the surface of stake 700.

An alternate preferred embodiment is depicted in FIG. 10B, where a box beam cleat with two opposing walls is depicted in side cross-section with a sex bolt engaging threaded member 710. An alternate preferred embodiment is shown in FIG. 10C, which depicts an end-view cross-section with threaded member 710 passing through a slot or hole in one side of a box-beam stake.

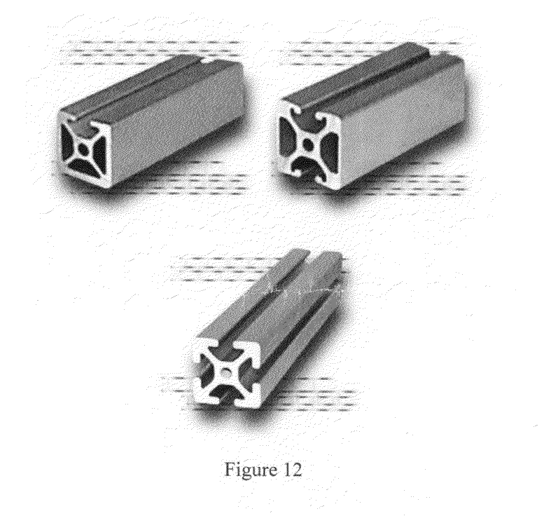

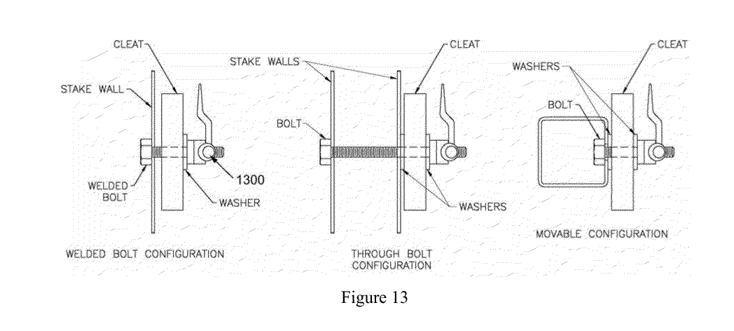

In an alternate preferred embodiment, an extruded stake such as one of the extruded stakes shown in FIG. 12 is used, and the threaded member of the present invention is a female threaded member whose threads engage the male threads of a bolt whose head is captured in a slot of an extruded stake. FIG. 13 depicts examples of alternate preferred embodiments of the present invention where female threaded member 1300 engages male bolt threads.

Within the claims of this document, the term “rubber” shall be construed to include natural and synthetic rubber, elastomers, and polymers with a Shore A Durometer between 20 and 95, or a Shore D Durometer between 45 and 85, or a Rockwell R hardness between 50 and 150.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. A clamping mechanism for clamping sheet material in place during transport, comprising:
a vehicle-mounted rack for transporting sheet material, including supporting surfaces and at least one metal stake which can support a mechanism to clamp sheet material against at least one of said supporting surfaces;
at least one rubber-surfaced cleat fastened to said stake by a fastening mechanism comprising: a cam with a surface eccentric about a first axis of rotation; a handle attached to said cam and operable to rotate said cam about said first axis of rotation; a threaded member which at a first end extends into a slot in said cam perpendicular to said first axis of rotation, and at a second end passes through at least one surface of said stake.

2. The clamping mechanism of claim 1, wherein the threads of said threaded member are male threads which engage the female threads of a nut welded to said stake.

3. The clamping mechanism of claim 1, wherein the threads of said threaded member are male threads which engage the female threads of a sex bolt and said stake is a box beam stake.

4. The clamping mechanism of claim 1, wherein the threads of said threaded member are male threads which engage the female threads of a nut slidably positioned in a slot in said stake.

5. The clamping mechanism of claim 1, wherein the threads of said threaded member are female threads which engage the male threads of a bolt and said stake is a box beam stake.

6. A clamping mechanism for clamping sheet material in place during transport, comprising:
a vehicle-mounted rack for transporting sheet material, including supporting surfaces and at least one metal stake which can support a mechanism to clamp sheet material against at least one of said supporting surfaces;
at least one rubber-surfaced cleat fastened to said stake by a fastening mechanism comprising: a cam with a surface eccentric about a first axis of rotation; a handle attached to said cam and operable to rotate said cam about said first axis of rotation; a first threaded member which at a first end extends into a slot in said cam perpendicular to said first axis of rotation, and at a second end engages an opposite-sex threaded member protruding from said stake.

7. The clamping mechanism of claim 6, wherein said first and second end of said threaded member are spatially coincident.
